(19) United States
(12) Patent Application Publication
(10) Pub. No.: US 2014/0007841 A1
(43) Pub. Date: Jan. 9, 2014

(54) CONTROL APPARATUS FOR INTERNAL COMBUSTION ENGINE

(71) Applicant: Takashi Kawai, Susono-shi (JP)

(72) Inventor: Takashi Kawai, Susono-shi (JP)

(73) Assignee: TOYOTA JIDOSHA KABUSHIKI KAISHA, Toyota-shi, Aichi-ken (JP)

(21) Appl. No.: 13/635,796

(22) PCT Filed: Mar. 22, 2011
(86) PCT No.: PCT/JP11/56813

§ 371 Date: Sep. 18, 2012

(51) Int. Cl. F02M 69/00

(52) U.S. Cl. CPC F02M 69/00
USPC 123/445

(57) ABSTRACT

A control apparatus for an internal combustion engine is provided, which can favorably suppress an occurrence of abnormal combustion in the case of including a fuel injection valve capable of injecting a fuel by dividing the fuel in any desired number of times of division by using at least one of an intake stroke and a compression stroke.

A direct-injection injector (16) is included, which is capable of injecting a fuel by dividing the fuel in any desired number of times of division by using at least one of the intake stroke and the compression stroke during one cycle of an internal combustion engine (10). When an occurrence of abnormal combustion of the internal combustion engine (10) is detected or predicted, the number of times of division of fuel injection is decreased as compared with a case in which the occurrence of the abnormal combustion is not detected or predicted.

### TECHNICAL FIELD

The present invention relates to a control apparatus for an internal combustion engine, and particularly to a control apparatus for an internal combustion engine which is preferable in controlling an internal combustion engine including a fuel injection valve capable of injecting a fuel by dividing the fuel in any desired number of times of division by using at least one of an intake stroke and a compression stroke.

### BACKGROUND ART

Conventionally, for example, Patent Document 1 discloses a control apparatus for a spark ignition type cylinder injection internal combustion engine. In the conventional control apparatus, fuel injection is performed by being divided into an intake stroke and a compression stroke when an occurrence of knocking is detected. Further, the Patent Document 1 describes a control example in which the number of times of division for intake stroke injection is increased by one when fuel injection pressure exceeds a predetermined value when the occurrence of knocking is detected.

### CITATION LIST

### Patent Documents

Patent Document 1: Japanese Laid-open Patent Application Publication No. 2006-329158

### SUMMARY OF INVENTION

### Technical Problem

As one of the causes of the occurrence of abnormal combustion such as pre ignition and knocking in a low-revolution and high-load region of an internal combustion engine, presence of fuel spray with a large particle size is conceivable. More specifically, fuel spray with a large particle size itself or oil in a cylinder combined with such fuel spray may cause abnormal combustion.

At the early stage of injection and the last stage of the injection of a fuel by a fuel injection valve, the flow velocity of the injected fuel is reduced, as a result of which, the particle size of the fuel spray becomes large. Accordingly, if the number of times of division of fuel injection is increased when an occurrence of knocking is detected as in the technique described in the Patent Document 1, fuel spray with a large particle size increases, and a concern is that abnormal combustion such as knocking is likely to occur under certain circumstances.

The present invention has been made to solve the problem as described above, and an object of the invention is to provide a control apparatus for an internal combustion engine capable of favorably suppressing an occurrence of abnormal combustion in the case of including a fuel injection valve capable of injecting a fuel by dividing the fuel in any desired number of times of division by using at least one of an intake stroke and a compression stroke.

### Solution to Problem

A first aspect of the present invention is a control apparatus for an internal combustion engine, comprising:

a fuel injection valve which is capable of injecting a fuel by dividing the fuel in any desired number of times of division by using at least one of an intake stroke and a compression stroke during one cycle of the internal combustion engine;

abnormal combustion determining means which detects or predicts an occurrence of abnormal combustion of the internal combustion engine; and

abnormal combustion time fuel injection control means which decreases the number of times of division of fuel injection as compared with a case in which the occurrence of the abnormal combustion is not detected or predicted, when the occurrence of the abnormal combustion is detected or predicted by the abnormal combustion determining means.

A second aspect of the present invention is the control apparatus for an internal combustion engine according to the first aspect of the present invention,

wherein the abnormal combustion time fuel injection control means forbids to divide fuel injection when the occurrence of the abnormal combustion is detected or predicted by the abnormal combustion determining means.

A third aspect of the present invention is the control apparatus for an internal combustion engine according to the first or second aspect of the present invention,

wherein the abnormal combustion time fuel injection control means stops one or a plurality of fuel injections in an order of later fuel injection timing when decreasing the number of times of division of fuel injection.

A fourth aspect of the present invention is the control apparatus for an internal combustion engine according to any one of the first or second aspect of the present invention,

wherein the abnormal combustion time fuel injection control means stops fuel injection near an intake bottom dead center when decreasing the number of times of division of fuel injection.

A fifth aspect of the present invention is the control apparatus for an internal combustion engine according to the first or second aspect of the present invention,

wherein the abnormal combustion time fuel injection control means stops one or a plurality of fuel injections that is set at an early stage of the intake stroke when decreasing the number of times of division of fuel injection.

A sixth aspect of the present invention is the control apparatus for an internal combustion engine according to the first to fifth aspects of the present invention,

wherein the internal combustion engine is an internal combustion engine with a supercharger.

### Advantageous Effects of Invention

According to the first aspect of the present invention, when an occurrence of abnormal combustion is detected or predicted, the number of times of division of fuel injection is decreased as compared with the case in which the occurrence of the abnormal combustion is not detected or predicted. Thereby, the number of arrivals of the early stage of injection and the last stage of injection of the fuel during one cycle is reduced, and therefore, fuel spray with a large particle size can be decreased. As a result, abnormal combustion caused by the presence of the fuel injection with a large particle size can be favorably suppressed.

According to the second aspect of the present invention, when an occurrence of abnormal combustion is detected or predicted, it is forbidden to divide the fuel injection. Thereby, each of the numbers of arrivals of the early stage of injection and the last stage of the injection of the fuel during one cycle is reduced to one, and therefore, fuel spray with a large particle size can be decreased. As a result, abnormal combustion caused by the presence of fuel spray with a large particle size can be favorably suppressed.

According to the third aspect of the present invention, generation of fuel spray with a particle size can be more decreased when the number of times of division of fuel injection is decreased.

According to the fourth aspect of the present invention, fuel spray with a large particle size can be favorably restrained from being combined with oil adhering onto a cylinder bore and being the cause of occurrence of abnormal combustion, when the number of times of division of fuel injection is decreased.

According to the fifth aspect of the present invention, fuel spray with a large particle size can be favorably restrained from being combined with oil adhering onto a cylinder bore at the intake side and being the cause of occurrence of abnormal combustion, when the number of times of division of fuel injection is decreased.

According to the sixth aspect of the present invention, in the internal combustion engine with a supercharger in which abnormal combustion is likely to occur in a low-revolution and high-load region as compared with a natural aspiration type internal combustion engine, abnormal combustion caused by the presence of fuel spray with a large particle size can be favorably suppressed.

### BRIEF DESCRIPTION OF DRAWINGS

FIG. 1 is a diagram for explaining a system configuration of an internal combustion engine 10 according to a first embodiment of the present invention;

FIG. 2 is a diagram showing one example of division injection using a direct-injection injector;

FIG. 3 is a diagram showing a behavior of a spray particle size after start of fuel injection; and

FIG. 4 is a flowchart of a routine that is executed in the first embodiment of the present invention.

### DESCRIPTION OF EMBODIMENTS

### First Embodiment

### Explanation of System Configuration

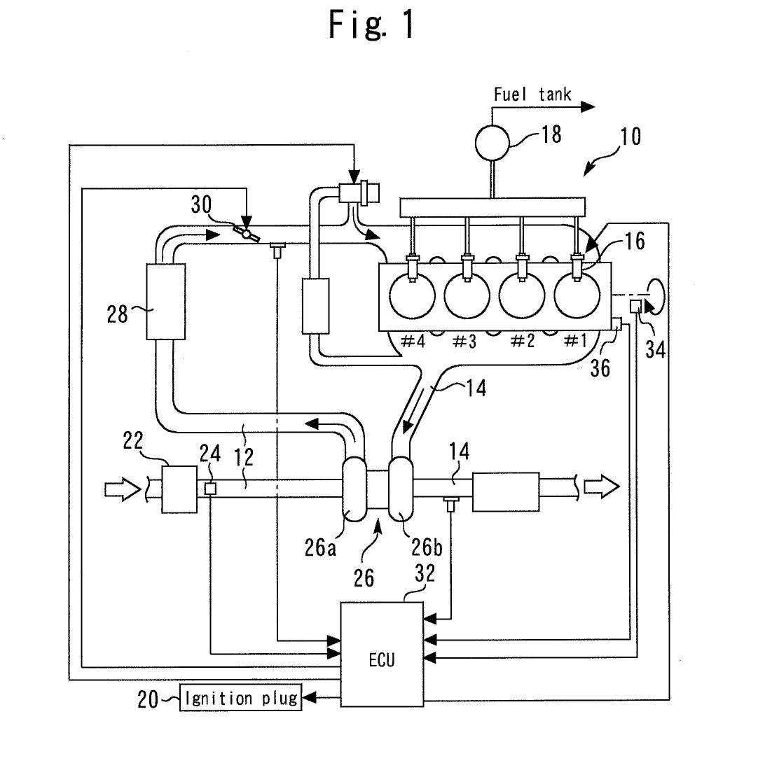

FIG. 1 is a diagram for explaining a system configuration of an internal combustion engine 10 according to a first embodiment of the present invention. A system of the present embodiment includes the spark ignition type internal combustion engine (gasoline engine) 10. An intake passage 12 and an exhaust passage 14 communicate with each of cylinders of the internal combustion engine 10. Further, each of the cylinders of the internal combustion engine 10 is provided with a direct-injection injector 16 for directly injecting a fuel into the cylinder. A fuel which is pressurized by a high-pressure pump 18 is supplied to each of the direct-injection injectors 16. Further, each of the cylinders of the internal combustion engine 10 is provided with an ignition plug 20 for igniting a mixture gas.

An air cleaner 22 is attached in the vicinity of an inlet of the intake passage 12. An air flow meter 24 which outputs a signal corresponding to a flow rate of air which is taken into the intake passage 12 is provided in the vicinity of a downstream side of the air cleaner 22. A compressor 26a of a turbo supercharger 26 is installed downstream of the air flow meter 24.

The compressor 26a is integrally connected to a turbine 26b which is placed in the exhaust passage 14 via a connecting shaft. An inter cooler 28 which cools compressed air is provided downstream of the compressor 26a. An electronic control throttle valve 30 is provided downstream of the inter cooler 28.

Further, the system shown in FIG. 1 includes an ECU (Electronic Control Unit) 32. Various sensors for detecting the operation state of the internal combustion engine 10, such as a crank angle sensor 34 for detecting an engine speed, and a knock sensor (vibration sensor) 36 for detecting abnormal combustion such as knocking and pre ignition are connected to an input section of the ECU 32, in addition to the aforementioned air flow meter 24. Further, various actuators for controlling the operation of the internal combustion engine 10, such as the direct-injection injector 16, the ignition plug 20 and the throttle valve 30 which are described above are connected to an output section of the ECU 32. The ECU 32 controls the operation state of the internal combustion engine 10 by operating various actuators in accordance with predetermined programs based on the outputs of the aforementioned various sensors.

### Control in First Embodiment

According to the system of the present embodiment including the aforementioned direct-injection injector 16, intake stroke injection that injects a fuel during an intake stroke, and compression stroke injection that injects a fuel during a compression stroke can be executed as injection modes of the fuel. Further, according to the present system, fuel injection that performs fuel injection by dividing a required fuel injection amount in any desired number of times of division (hereinafter, called “division injection”) can be executed in the intake stroke and the compression stroke in the same cycle.

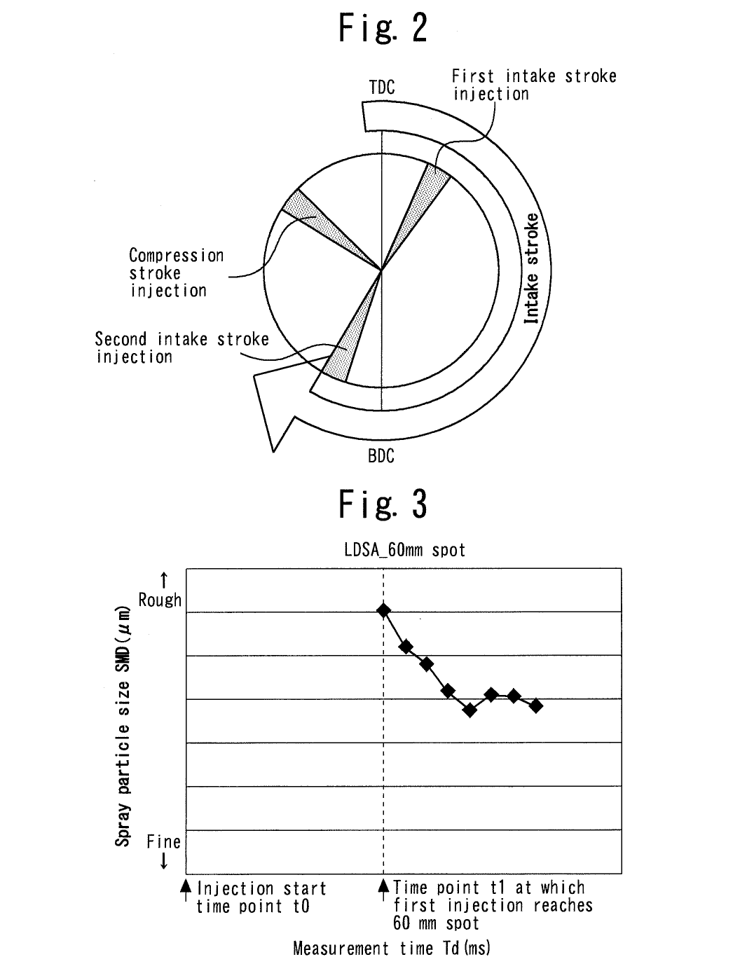

FIG. 2 is a diagram showing one example of the division injection using the direct-injection injector 16. Here, fuel injection that is performed during a valve opening period of the intake valve is called “intake stroke injection”, and fuel injection that is performed during a period in which compression of the cylinder gas is actually performed after the intake valve is closed is called “compression stroke injection”.

The division injection shown in FIG. 2 shows the example in which the first intake stroke injection is performed in the early stage of the intake stroke, and after the second intake stroke injection is performed next immediately before the intake valve is closed, compression stroke injection is performed in the latter half period of the compression stroke. In this connection, modes of the division injection include, for example, a mode of performing only a plurality of times of intake stroke injection, or a mode of performing only a plurality of times of compression stroke injection, besides the mode of performing at least one fuel injection in each of both the intake stroke and the compression stroke as shown in FIG. 2.

FIG. 3 is a diagram showing a behavior of a spray particle size after start of fuel injection. More specifically, FIG. 3 shows a result of measuring a time change of a spray particle size SMD (Sauter's mean diameter) in a position 60 mm under a spray hole of the direct-injection injector 16, by using an LDSA (Laser Diffraction Spray Analyzer).

A time t1 in FIG. 3 represents a time point at which fuel spray which is first injected reaches the position 60 mm under the injection hole of the direct-injection injector 16, after the fuel injection is started at a time t0. From FIG. 3, it is found that the spray particle size SMD of the fuel which reaches the position 60 mm under the injection hole of the direct-injection injector 16 is rough in the early stage of the injection of the fuel, and thereafter, becomes fine. The reason why the spray particle size SMD is rough in the early stage of the injection of such fuel is that the flow velocity of the injected fuel is low.

Incidentally, as one of the causes of occurrence of abnormal combustion such as pre ignition and knocking in the low-revolution and high-load region (highly supercharging region) of the internal combustion engine 10, the presence of fuel spray with a large particle size is conceivable. More specifically, the fuel spray with a large particle size itself or the oil in the cylinder combined with such fuel spray may cause abnormal combustion.

As described above with reference to FIG. 3, at the early stage of the injection of the fuel by the direct-injection injector 16, the flow velocity of the injected fuel is low, and therefore, the particle size of the fuel spray becomes large (rough). Similarly, at the last stage of the injection of the fuel, the particle size of the fuel spray becomes large due to reduction in the flow velocity of the injected fuel. Accordingly, as the number of times of division of fuel injection becomes larger, the number of arrivals of the early stage of injection and the last stage of injection of the fuel increases, and therefore, fuel spray with a large particle size increases. As a result, if division injection is performed in a low-revolution and high-load region, a concern is that abnormal combustion such as knocking is likely to occur under certain circumstances.

Thus, in the present embodiment, execution of division injection is forbidden when the division injection is executed in a case in which the occurrence of abnormal combustion such as pre ignition and knocking is detected.

### (Specific Processing in First Embodiment)

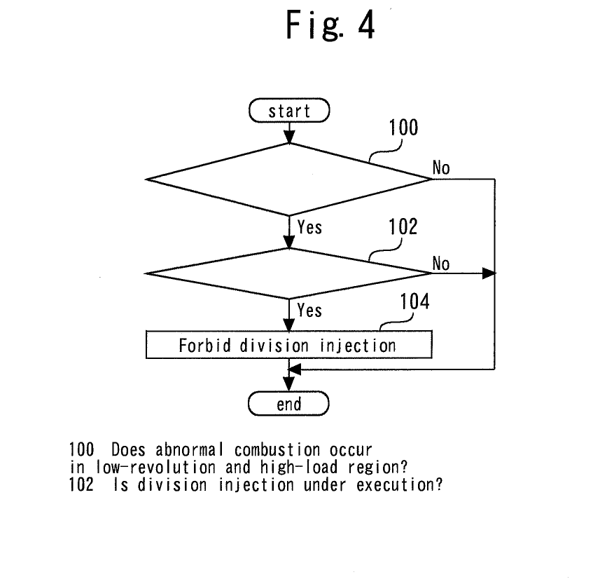

FIG. 4 is a flowchart showing a control routine to be executed by the ECU 32 in order to realize the control of the present first embodiment described above. In this connection, it is assumed that the present routine is repeatedly executed at each predetermined control period.

In the routine shown in FIG. 4, first, it is determined whether or not an occurrence of abnormal combustion is detected in a low-revolution and high-load region of the internal combustion engine 10 (step 100). More specifically, in present step 100, as one example, presence or absence of an occurrence of abnormal combustion such as knocking and pre ignition is determined by using the knock sensor 36. It is noted that the method for determining presence or absence of an occurrence of abnormal combustion may be performed by the prediction as follows, for example, instead of the above described method. More specifically, for example, the map (not illustrated) in which a predetermined low-revolution and high-load region (abnormal combustion occurrence region) with a high possibility of occurrence of pre ignition, knocking or the like is set in advance by using a relation of torque (intake air amount) and an engine speed is stored in the ECU 32. Subsequently, when the present operation region (torque and engine speed) is in the abnormal combustion occurrence region, an occurrence of abnormal combustion may be predicted with reference to such a map.

When an occurrence of abnormal combustion is detected in aforementioned step 100, it is determined whether or not division injection is under execution (step 102). When it is determined that division injection is under execution as a result, execution of the division injection is forbidden (step 104). As a result, in this case, the fuel injection is changed from the division injection which is performed with the number of times of division being two or more (three times in the example shown in FIG. 2) to single injection at a each predetermined injection timing.

According to the routine shown in FIG. 4 which is described above, when division injection is executed in a case in which an occurrence of abnormal combustion is detected, execution of the division injection is forbidden. In other words, in this case, the number of times of division of the fuel injection is decreased to be one. Thereby, the number of arrivals of the early stage of injection and the last stage of injection of the fuel during one cycle is reduced, and therefore, fuel spray with a large particle size can be reduced. As a result, abnormal combustion caused by the presence of fuel spray with a large particle size can be favorably suppressed.

Incidentally, in the aforementioned first embodiment, execution of division injection is forbidden (namely, the number of times of division of fuel injection is changed to one) when the division injection is executed in a case in which an occurrence of abnormal combustion is detected. However, the present invention is not limited to the method which forbids execution of division injection. More specifically, when an occurrence of abnormal combustion is detected or predicted while fuel injection is performed in three or more desired times of division, the desired number of times of division may be decreased to two or more times of division of the fuel injection.

Further, when the number of times of division of the fuel injection is decreased, the fuel injection which is an object to be decreased may be determined in the mode as follows. More specifically, one or a plurality of fuel injections may be stopped in the order of later fuel injection timing. For example, when the number of times of division is decreased to two in the example shown in FIG. 2 in which fuel injection is performed three times, the compression stroke injection the fuel injection timing of which is the last is stopped. As the fuel injection timing is later, the time until a predetermined ignition time after the fuel is injected is shorter, and therefore, it becomes difficult to ensure the time for promoting atomization of the fuel after injection. Therefore, stopping one or a plurality of fuel injections in the order of later fuel injection timing can be said as a preferable method in decreasing generation of fuel spray with a large particle size when the number of times of division of fuel injection is decreased.

Further, when the number of times of division of fuel injection is decreased, fuel injection which is an object to be decreased may be determined in the mode as follows. More specifically, one or a plurality of fuel injections near the intake bottom dead center may be stopped, for example. For example, when the number of times of division is decreased to two in the example shown in FIG. 2 in which fuel injection is performed three times, the second intake stroke injection which is performed immediately before closing of the intake valve is stopped. If the fuel injection is performed at timing near the intake bottom dead center by the direct-injection injector 16, the injected fuel easily adheres to the cylinder bore. Therefore, stopping the fuel injection at such timing can be said as a preferable method in restraining the fuel spray with a large particle size from being combined with oil adhering onto the cylinder bore and becoming a cause of occurrence of abnormal combustion when the number of times of division of the fuel injection is decreased.

Further, when the number of times of division of fuel injection is decreased, the fuel injection which is an object to be decreased may be determined in the mode as follows. More specifically, one or a plurality of fuel injections which are set at an early stage of the intake stroke may be stopped, for example. For example, when the number of times of division is decreased to two in the example shown in FIG. 2 in which fuel injection is performed three times, the first intake stroke injection which is performed at the early stage of the intake stroke is stopped. When fuel injection is performed at the early stage of the intake stroke by the direct-injection injector 16, the injected fuel easily adheres to the cylinder bore at the intake side. Therefore, stopping the fuel injection at such timing can be said as a preferable method in restraining the fuel spray with a large particle size from being combined with oil adhering onto the cylinder bore at the intake side and becoming a cause of occurrence of abnormal combustion when the number of times of division of fuel injection is decreased.

Further, in the aforementioned first embodiment, the description is made with the internal combustion engine 10 including the turbo supercharger 26 as an example. However, the internal combustion engine to which the present invention is applied is not necessarily limited to an internal combustion engine including a supercharger such as the turbo supercharger 26, and may be a natural aspiration type internal combustion engine. However, in the internal combustion engine with a supercharger, abnormal combustion occurs more easily in a low-revolution and high-load region. Accordingly, the effect by the present invention becomes more remarkable in the case in which the present invention is applied to an internal combustion engine with a supercharger.

Further, in the aforementioned first embodiment, the description is made with the internal combustion engine 10 including the direct-injection injector 16 which directly injects a fuel into the cylinder as an example. However, the fuel injection valve to which the present invention is applied is not necessarily limited to the direct-injection injector 16. More specifically, the fuel injection valve may be the one that performs intake stroke injection with the number of times of division of two or more by using a port injection type fuel injection valve which injects a fuel into an intake port.

In the aforementioned first embodiment, the direct-injection injector 16 corresponds to the “fuel injection valve” of the aforesaid first aspect of the present invention. Further, the “abnormal combustion determining means” according to the aforesaid first aspect of the present invention is realized by the ECU 32 executing the determination in aforementioned step 100, and the “abnormal combustion time fuel injection control means” according to the aforesaid first aspect of the present invention is realized by the ECU 32 executing the processing of aforementioned step 104 when the determination in aforementioned steps 100 and 102 is established.

### DESCRIPTION OF SYMBOLS

10 internal combustion engine

12 intake passage

14 exhaust passage

16 direct-injection injector

18 high-pressure pump

20 ignition plug

24 air flow meter

26 turbo supercharger

26a compressor

26b turbine

30 throttle valve

32 ECU (Electronic Control Unit)

34 crank angle sensor

36 knock sensor

1. A control apparatus for an internal combustion engine, comprising:
a fuel injection valve which is capable of injecting a fuel in a plurality of batches in at least one of an intake stroke and a compression stroke during one cycle of the internal combustion engine;
abnormal combustion determining means which detects or predicts an occurrence of abnormal combustion of the internal combustion engine; and
abnormal combustion time fuel injection control means which reduces a frequency of fuel injection during one cycle as compared with a case in which the occurrence of the abnormal combustion is not detected or predicted, when the occurrence of the abnormal combustion is detected or predicted by the abnormal combustion determining means.

2. The control apparatus for an internal combustion engine according to claim 1,
wherein the abnormal combustion time fuel injection control means forbids to inject a fuel in a plurality of batches when the occurrence of the abnormal combustion is detected or predicted by the abnormal combustion determining means.

3. The control apparatus for an internal combustion engine according to claim 1,
wherein the abnormal combustion time fuel injection control means stops one or a plurality of fuel injections in an order of later fuel injection timing when reducing the frequency of fuel injection.

4. The control apparatus for an internal combustion engine according to claim 1,
wherein the abnormal combustion time fuel injection control means stops one or a plurality of fuel injections near an intake bottom dead center when reducing the frequency of fuel injection.

5. The control apparatus for an internal combustion engine according to claim 1,
wherein the abnormal combustion time fuel injection control means stops one or a plurality of fuel injections that is set at an early stage of the intake stroke when reducing the frequency of fuel injection.

6. The control apparatus for an internal combustion engine according to claim 1,
wherein the internal combustion engine is an internal combustion engine with a supercharger.

7. A control apparatus for an internal combustion engine, comprising:
a fuel injection valve which is capable of injecting a fuel in a plurality of batches in at least one of an intake stroke and a compression stroke during one cycle of the internal combustion engine; and
a controller that is programmed to:
detect or predict an occurrence of abnormal combustion of the internal combustion engine; and
reduce a frequency of fuel injection during one cycle as compared with a case in which the occurrence of the abnormal combustion is not detected or predicted, when the occurrence of the abnormal combustion is detected or predicted by the controller.
